(19) United States
(12) Patent Application Publication
(10) Pub. No.: US 2015/0254587 A1
(43) Pub. Date: Sep. 10, 2015

(54) ESTIMATES USING HISTORICAL ANALYSIS

(71) Applicant: International Business Machines Corporation, Armonk, NY (US)

(72) Inventor: Thomas C. Loffing, Marysville, OH (US)

(73) Assignee: International Business Machines Corporation, Armonk, NY (US)

(21) Appl. No.: 14/202,339

(22) Filed: Mar. 10, 2014

(51) Int. Cl. G06Q 10/06

(52) U.S. Cl. CPC G06Q 10/06313

(57) ABSTRACT

A computer-implemented method, computer program product, and computing system are provided for improving anecdotal estimates of resources required for completing a task. In an embodiment, the method may include defining a task. The method may also include defining a plurality of components associated with the task. The method may also include receiving a raw estimate of an amount of resources required for accomplishing a component of the plurality of components from an estimator. The method may further include generating an adjusted estimate of the amount of resources required for accomplishing the component based upon, at least in part a historical accuracy associated with the estimator.

### TECHNICAL FIELD

The present disclosure generally relates to systems and method for estimating resource needs for completing various tasks.

### BACKGROUND

Many business processes rely on the estimation of the amount of resources required to complete complex tasks. For some processes the requirements may be clearly defined. For example, a well established manufacturing process may have clearly defined requirements for materials, energy, labor, and the like. However many business processes may not have such a high degree of repeatability or certainty. Therefore, it may often be necessary to estimate the resources that may be required to complete tasks. Such estimates may be related to the amount of time necessary to accomplish a task, the raw materials required to accomplish the task, and the like. While individuals may have different tools or guides that can assist in making the necessary estimates, it is often the case that an estimate will come down to the individual's experience and judgment.

### SUMMARY OF DISCLOSURE

According to an implementation, a computer-implemented method may include defining, by a computing device, a task. The method my also include defining a plurality of components associated with the task. The method may also include receiving a raw estimate of an amount of resources required for accomplishing a component of the plurality of components from an estimator. The method may further include generating an adjusted estimate of the amount of resources required for accomplishing the component based upon, at least in part a historical accuracy associated with the estimator.

One or more of the following features may be included. Generating the adjusted estimate may include determining an accuracy of one or more prior estimates by the estimator. An adjustment metric may be determined based upon, at least in part, the accuracy of the one or more prior estimates by the estimator. The adjustment metric may be applied to the raw estimate.

The method may also include determining the actual amount of resources utilized for accomplishing the component. The raw estimate may be compared with actual amount of resources. An accuracy associated with the raw estimate may be determined. An adjustment metric may be updated based upon, at least in part, the determined accuracy associated with the raw estimate. The adjustment metric may be utilized, at least in part for generating the adjusted estimate.

The method may also include generating a numerical analysis of one or more of the raw estimate and the adjusted estimate. The method may also include generating a numerical analysis associated with the estimator and with one or more of the plurality of components.

According to another implementation, a computer program product may include a computer readable medium having a plurality of instructions stored on it. When executed by a processor, the instructions may cause the processor to perform operations including defining a task. Instructions may also be included for defining a plurality of components associated with the task. Instructions may also be included for receiving a raw estimate of an amount of resources required for accomplishing a component of the plurality of components from an estimator. Instructions may further be included for generating an adjusted estimate of the amount of resources required for accomplishing the component based upon, at least in part a historical accuracy associated with the estimator.

One or more of the following features may be included. Generating the adjusted estimate may include determining an accuracy of one or more prior estimates by the estimator. An adjustment metric may be determined based upon, at least in part, the accuracy of the one or more prior estimates by the estimator. Instructions may be included for applying an adjustment metric to the raw estimate.

Instructions may be included for determining the actual amount of resources utilized for accomplishing the component. The raw estimate may be compared with actual amount of resources. An accuracy associated with the raw estimate may be determined. Instructions may also be included for updating an adjustment metric based upon, at least in part, the determined accuracy associated with the raw estimate. The adjustment metric may be utilized, at least in part for generating the adjusted estimate.

Instructions may also be included for generating a numerical analysis of one or more of the raw estimate and the adjusted estimate. Instructions may also be included for generating a numerical analysis associated with the estimator and with one or more of the plurality of components.

According to another implementation, a computing system may include a processor device and a memory module coupled with the processor device. The processor device may be configured for defining a task. The processor device may also be configured for defining a plurality of components associated with the task. The processor device may also be configured for receiving a raw estimate of an amount of resources required for accomplishing a component of the plurality of components from an estimator. The processor device may further be configured for generating an adjusted estimate of the amount of resources required for accomplishing the component based upon, at least in part a historical accuracy associated with the estimator.

One or more of the following features may be included. Generating the adjusted estimate may include determining an accuracy of one or more prior estimates by the estimator. An adjustment metric may be determined based upon, at least in part, the accuracy of the one or more prior estimates by the estimator. The processor device may also be configured for applying an adjustment metric to the raw estimate.

The processor device may be further configured for determining the actual amount of resources utilized for accomplishing the component. The raw estimate may be compared with an actual amount of resources. An accuracy associated with the raw estimate may be determined. The processor device may be further configured for updating an adjustment metric based upon, at least in part, the determined accuracy associated with the raw estimate. The adjustment metric may be utilized, at least in part for generating the adjusted estimate.

The processor device may be further configured for generating a numerical analysis of one or more of the raw estimate and the adjusted estimate.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a estimating process according to an implementation of the present disclosure;

FIG. 2 is a flowchart of the estimating process of FIG. 1, according to an implementation of the present disclosure;

FIG. 3 is diagrammatic representation of an example estimating process of FIG. 1, according to an implementation of the present disclosure;

FIG. 4 is a diagrammatic view of the computing device of FIG. 1, according to an implementation of the present disclosure.

Like reference symbols in the various drawings indicate like elements.

### DETAILED DESCRIPTION

Many business processes depend upon estimations of the amount of resources that will be required to complete a task. The resources required for the completion of the task may include materials, energy, time, manpower, etc. While some tasks have fixed or readily calculable requirements, the requirements for many tasks may be susceptible to variation or the needs may not be easily calculated. For example, the amount of time (e.g., which may include both linear time as well as hours of labor, etc.) required to build a house or develop a software application may not be easily calculated based upon some standard formula. Estimates of the resource requirements for completing such tasks may often be based upon the experience, skill, and judgment of the individual who is making the estimate. Such estimates may be termed “anecdotal estimates” because they are based on the knowledge, experience, and perspective of the person making the estimate, rather than an objective standard.

In an embodiment, the present disclosure may facilitate improving the accuracy of anecdotal estimates. For example, the accuracy and/or validity of anecdotal estimates may vary based on the individual making the estimate, the nature of the task, the circumstances under which the task must be completed, and the like. In an embodiment, the present disclosure may allow anecdotal estimates to be adjusted based upon the historical accuracy of other estimates that have been made by the individual providing the anecdotal estimate. For example, in an embodiment, a task for which an estimate may be provided is defined. The task may be broken up into a plurality of components, which may make up the task. A raw estimate may be received from the individual making the estimate (e.g., the estimator). The raw estimate may include a anecdotal estimate of the resources required to perform the task. As such, the raw estimate may be based upon, at least in part, the knowledge, experience, and judgment of the estimator, as well as any other tools of guides that the estimator may use in arriving at the anecdotal estimate.

In an example embodiment, the present disclosure may generate an adjusted estimate of the amount of resources required for accomplishing at least one component of the task, and/or for accomplishing the entire task (e.g., which may include an aggregate of the resources required for accomplishing each of the components making up the task). The adjusted estimate may be based upon, at least in part, a historical accuracy associated with the estimator. According to such an embodiment, the adjusted estimate may be automatically generated based upon, for example, any one or more of the estimator, the raw estimate, the task, the component, the nature of the resources being estimated, etc. In some embodiments, generating the adjusted estimate may include determining an accuracy of prior estimates by the given estimator. An adjustment metric may be determined based upon the prior accuracy of the prior estimates, and the adjustment metric may be applied to the raw estimate. As such, an adjustment may be generated that may be specific to an individual estimator and to a specific task and/or a specific component of a task.

In some embodiments, a feedback, or learning, functionality may be implemented. For example, the actual amount of resources that are utilized to accomplish the component may be compared with the raw estimate by the estimator to determine the accuracy of the raw estimate and/or the accuracy of the adjusted estimate. An adjustment metric (e.g., which may be used for determining an adjusted estimate based upon, at least in part, the raw estimate) may be updated based upon, at least in part, the accuracy of the raw estimate and/or the accuracy of the adjusted estimate. For example, based upon, at least in part, the accuracy of the adjusted estimate compared to the actual amount of resources utilized, the adjustment metric may be updated, or refined, to provide more accurate future adjusted estimates for the given estimator.

In some implementations, the present disclosure may allow for a variety of numerical analyses to be conducted to uncover meaningful trends, correlations, and/or characteristics associated with one or more of the estimator, the tasks, the components, and the adjusted estimates. For example, a broad deviation between adjusted estimates and actual resources utilized extending over a large number of estimates by the same estimator may indicate that the estimator is inconsistent, and therefore the raw estimates are not able to be compensated for. A wide variance for a given task or component across all estimators may indicate that the task or component presents a great deal of difficulty in estimating the requires. Various additional/alternative trend, correlations, and/or characteristics may be realized through numerical analysis of the estimates and adjustment metrics relative to estimators, tasks, and the like.

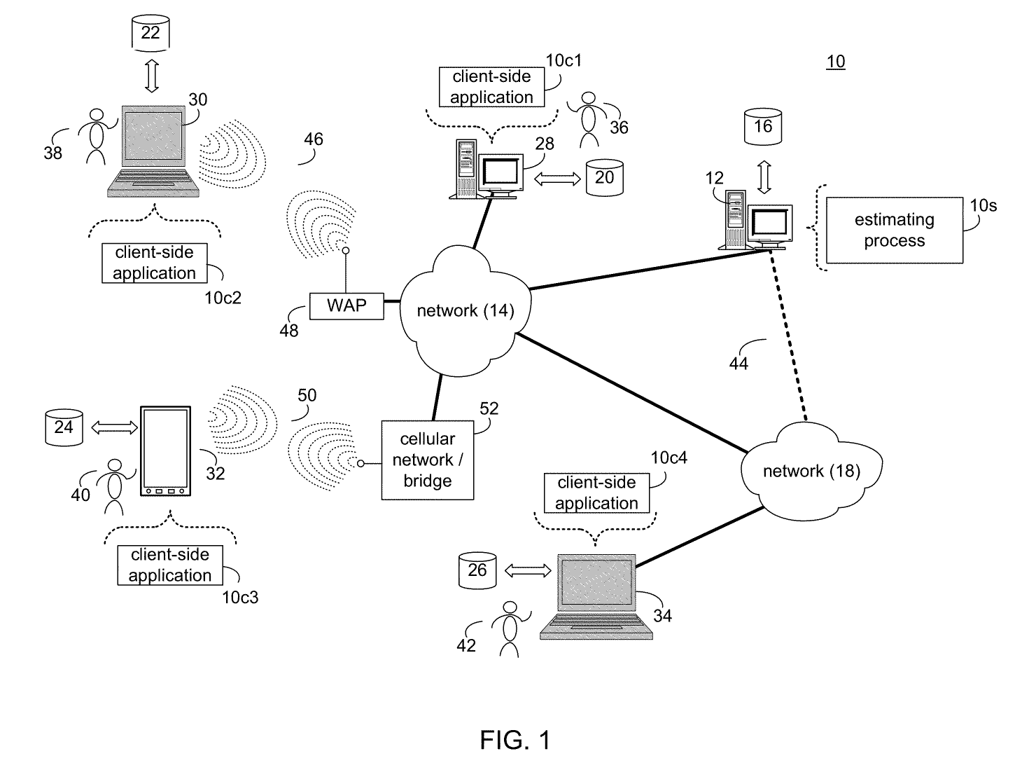

Referring to FIG. 1, there is shown estimating process 10. For the following discussion, it is intended to be understood that estimating process 10 may be implemented in a variety of ways. For example, estimating process 10 may be implemented as a server-side process, a client-side process, or a server-side/client-side process.

For example, estimating process 10 may be implemented as a purely server-side process via estimating process 10s. Alternatively, estimating process 10 may be implemented as a purely client-side process via one or more of client-side application 10c1, client-side application 10c2, client-side application 10c3, and client-side application 10c4. Alternatively still, estimating process 10 may be implemented as a server-side/client-side process via screen estimating process 10s in combination with one or more of client-side application 10c1, client-side application 10c2, client-side application 10c3, and client-side application 10c4. In such an example, at least a portion of the functionality of estimating process 10 may be performed by estimating process 10s and at least a portion of the functionality of estimating process 10 may be performed by one or more of client-side application 10c1, 10c2, 10c3, and 10c3.

Accordingly, estimating process 10 as used in this disclosure may include any combination of estimating process 10s, client-side application 10c1, client-side application 10c2, client-side application 10c3, and client-side application 10c4.

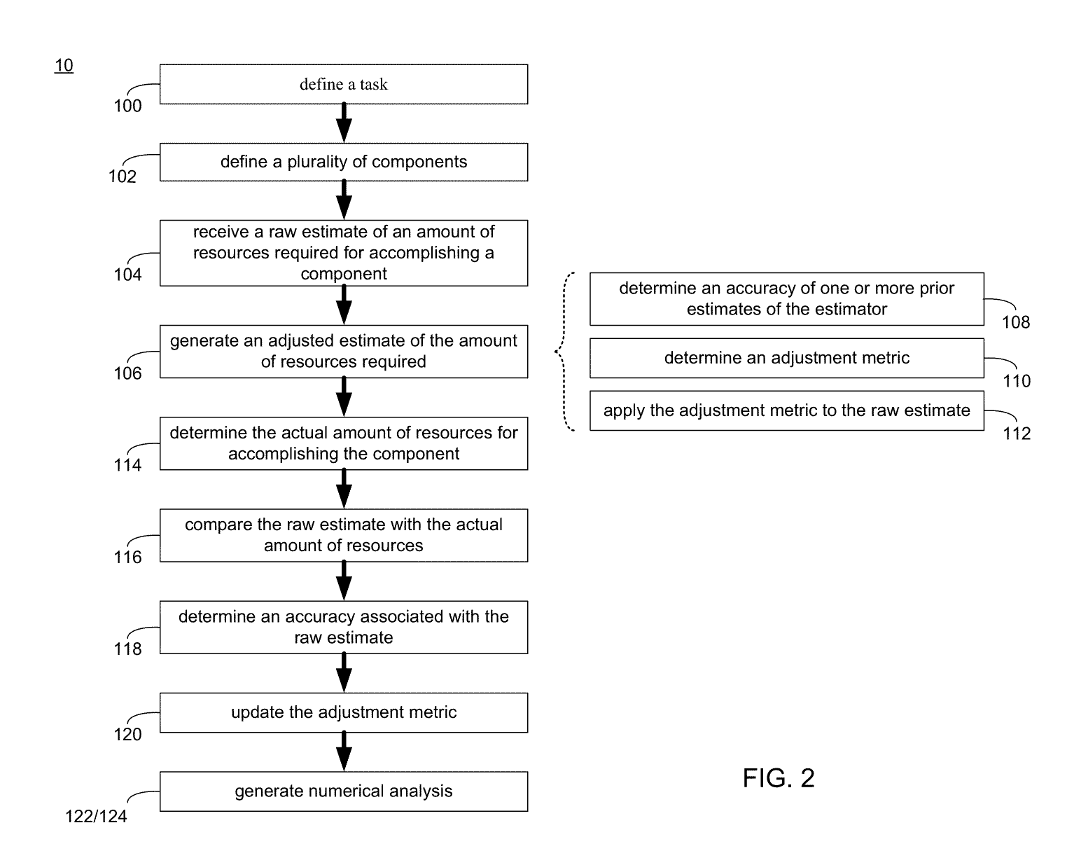

Referring also to FIG. 2, and as will be discussed in greater detail below, estimating process 10 may define 100 a task. Estimating process 10 may also define 102 a plurality of components associated with the task. Estimating process 10 may receive 104 a raw estimate of an amount of resources required for accomplishing a component of the plurality of components from an estimator. Estimating process 10 may further generate 106 an adjusted estimate of the amount of resources required for accomplishing the component based upon, at least in part a historical accuracy associated with the estimator.

Estimating process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of estimating process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, personal computer 28, laptop computer 30, mobile computing device 32, notebook computer 34, a netbook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access estimating process 10 directly through network 14 or through secondary network 18. Further, screen capture process 10 may be accessed through secondary network 18 via link line 44.

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channels 46 established between laptop computer 30 and wireless access point (WAP) 48. Similarly, mobile computing device 32 is shown wirelessly coupled to network 14 via wireless communication channel 50 established between mobile computing device 32 and cellular network/bridge 52, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Additionally, personal computer 34 is shown directly coupled to network 18 via a hardwired network connection.

As generally discussed above, and referring also to FIG. 2, estimating process 10 may define 100 a task. Estimating process 10 may also define 102 a plurality of components associated with the task. Estimating process 10 may receive 104 a raw estimate of an amount of resources required for accomplishing a component of the plurality of components from an estimator. Estimating process 10 may further generate 106 an adjusted estimate of the amount of resources required for accomplishing the component based upon, at least in part a historical accuracy associated with the estimator.

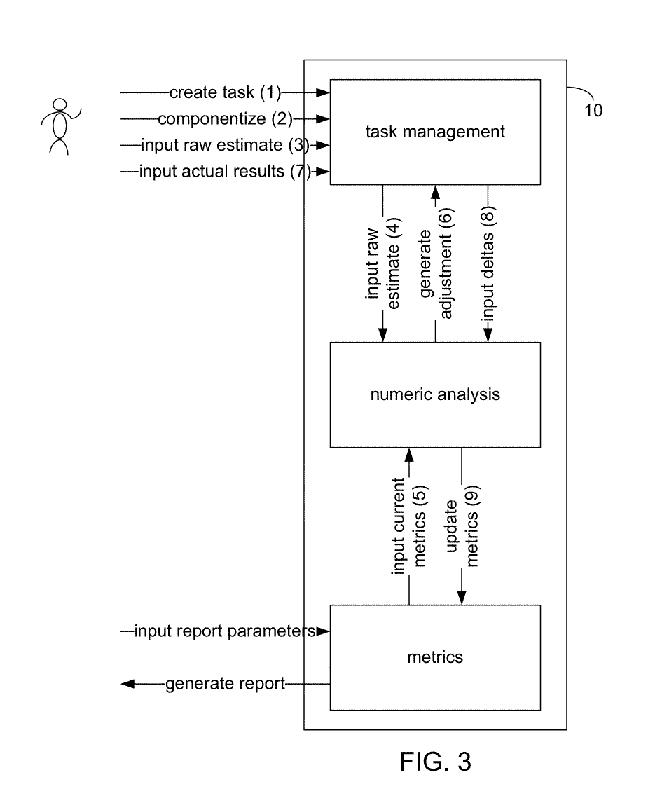

For example, and with additional reference to FIG. 3, estimating process 10 may define 100 a task. In an embodiment, defining 100 a task may include receiving a from a user (e.g., user 36) who may create a task within estimating process 10 (e.g., within a datastore, such as a database or the like). As generally discussed above, a task may include any business process or operation that may require the utilization of resources to complete the task. The resources may include actual physical resources, such as raw or processed materials, work units of manpower, energy, or any other resources. For example, a task may include the building of a house or housing development, which may require physical resources (e.g., lumber and/or other building materials) as well as labor resources (e.g., hours of labor by individuals having different skill sets, bulk labor resources such as a specified number of individuals working together at the same time, etc.), as well as various other resources. Similarly, a task may include the development of a software product (and/or a portion of a software product), which may require computing resources (e.g., processor cores or processor cycles for compiling and/testing the software product), versioning control system resources for managing revisions to the software product, labor resources (e.g., hours of labor by software developers and testers to design, code, and test the software product), and the like. It will be appreciated that the types of resources required may vary depending upon how a user creates the task, and/or the desired level granularity of the task. As such, tasks may be defined 100 with varying degrees of specificity depending upon system requirements, user needs, and the like.

It will be appreciated that tasks can be created having various different degrees of magnitude or granularity. Referring to the two examples discussed above, a task could include a more complex, or large scale, task such as building an entire house (or housing development) or could be a comparatively less complex, or smaller scale, task such as framing the second floor of a house, or rough plumbing a house. Similarly, a relatively complex, or large scale, task could include developing an entire software produce, which a relatively less complex, or smaller scale, task, could include developing a single feature within a software product. As such, the scale or complexity of the task may be defined 100 by estimating process 10 depending upon, at least in part, the user input creating the task within estimating process. As generally discussed above, defining 100 the task may include storing an identification of the task within a datastore associated with estimating process. Further, defining 100 the task may include associating various information with the task, such as the nature of the resources to be estimated, an identity of the creator of the task, an identity of an individual providing an estimate of the required resources, as well as various additional and/or alternative information. Information associated with the task may be stored in a datastore associated with, and/or accessible by, estimating process 10.

Estimating process 10 may also define 102 a plurality of components associated with the task. In an embodiment, the plurality of components may make up the task, and/or a portion of the task. For example, completion of the task may require completion of the plurality of components. As such, accomplishing each of the plurality of components may require the utilization of resources, such as physical resources, work or labor, or various other resources. Referring again to the previously discussed example, a task of building a house may include components such as framing the house, siding the house, rough plumbing the house, etc. The completing the example components may require the utilization of resources, such as raw materials (lumber, nails, the use of tools, labor, etc.). In the example of the development of a software product, a task may include adding a feature to the software products. Components of the task may include, for example, design an creation of user interface features, webservices, database interactions, testing, etc. The completion of the example components may require the utilization of resources, such as computing resources, labor (e.g., units of work for concept development, coding, test development and execution, debugging, etc.).

In an embodiment, defining 102 the plurality of components may include receiving an identification of the components associated with a given task from a user. For example, the number, type, and scope of the components (e.g., the componentization of the task) may be established by a user of estimating process 10. The breakdown and/or nature of the components defined 102 by estimating process may be required and/or necessary given the task, or there may be various different ways in which the components may be specified or grouped. In this regard, and in a similar manner as described above with respect to tasks, components may have varying degrees of complexity and/or scale. In some embodiments, similar, and/or the same, components may exist across different tasks and/or different types of tasks. For example, a component of coding webservices functionality may be a similar component of multiple different software development tasks associated with one or more different software products.

In some embodiments, one or more of defining the task and defining 102 the plurality of components may include selecting a task and/or selecting one or more components from a list of available options (i.e., available tasks and/or available components). For example, it may be the case that certain tasks, and/or types of tasks, may be encountered on more than one occasion. While one or more attributes of the task may vary from one instance to another instance (e.g., which may give rise to the desire to provide an estimate of the resources required to accomplish the task), one or more characteristics of the task may be common between the instances (such as a general description of the task, the types of resources required, one or more of the plurality of components, etc.). Similarly, it may be the case that certain components, and/or types of components, may be encountered on more than one occasion, either associated with similar task and/or different tasks (e.g., as generally discussed above). As such, which one or more attributes of the components may vary from one instance to another instance, one or more characteristics of the components may be common between instances. Consistent with the foregoing, in some embodiments, estimating process 10 may provide a selection (such as a list, drop-down menu, or the like) including one or more tasks and/or components that may be selected by a user. In such an embodiment, estimating process 10 may define 100, 102 a task and/or a component based upon, at least in part, a selection received from the user.

Estimating process 10 may receive 104 a raw estimate of an amount of resources required for accomplishing a component of the plurality of components from an estimator. The raw estimate received 104 by estimating process 10 may include an anecdotal estimate input by the individual making the estimate (e.g., the estimator). The raw estimate may be based upon, at least in part, the estimator's experience and knowledge of the task and/or components making up the task, as well as the estimator's judgment as to the resources that may be required to accomplish one or more components of the plurality of components associated with the task. In some embodiments, a single estimator may provide an estimate of the resources required to accomplish each of the plurality of components associated with the task. In some embodiments, more than one estimator may provide an estimate of resources required to accomplish different ones of the plurality of components associated with the task. As such, more than one estimator may contribute an estimate for components associated with a given task. In some such situations, estimating process 10 may associate an identity of each estimator with the specific components for which each estimator provided an estimate of resources required.

As generally discussed above, the raw estimate received 104 from the estimator may relate to a variety of different resource types, such as physical materials, units of work or labor, resources to be utilized for completing each component, and the like. Additionally, in some embodiments, more than one estimator may provide an estimate concerning different resources that may be utilized for accomplishing the same component. For example, in the case of developing a software product, in which a component includes developing the user interface, a first estimator may provide an estimate of the hours of labor required to write the code associated with the user interface, while another estimator may provide an estimate of the computing resources necessary to compile and test the code for the user interface. In some embodiments, writing the code for the user interface, compiling the source code for the user interface, and testing the user interface may each be a different component associated with the task of developing the software product. It will be appreciated that componentization, and accordingly the raw estimates received 104 from the estimators, may vary according to user need and/or specification.

Estimating process 10 may further generate 106 an adjusted estimate of the amount of resources required for accomplishing the component based upon, at least in part a historical accuracy associated with the estimator. As such, estimating process 10 may automatically generate an adjusted estimate of the resources required for accomplishing one or more components associated with a task based upon, at least in part, the historical accuracy of an individual estimator's estimates. Accordingly, historical information regarding the anecdotal resource estimates for accomplishing a component of a task that have been provided by an individual may be leveraged to provide adjusted estimates of the resources needed to accomplish the component. In some situations, the adjusted estimates may provide a higher degree of accuracy of the resources that may be required to accomplish the component of the task.

Generating 106 the adjusted estimate may include determining 108 an accuracy of one or more prior estimates by the estimator. For example, when the estimator makes an estimate, e.g., which may be input to estimating process, the task associated with the estimate, the component(s) associated with the estimate, and the estimated resources (e.g., which may include the resource type and estimated quantity) may be stored in a datastore, such as a database or other suitable datastore. Accordingly, estimating process 10, alone and/or in conjunction with another process, may store previous estimates made by the estimator. Additionally, after the task and/or the component associated with the estimate by the estimator has been completed, an input of the actual amount of resources associated with the task and/or the component may be received by estimating process 10. As such, estimating process 10 may, alone or in conjunction with another process, store actual resource utilization results associated with the previous estimates by the estimator. Further, in some embodiments, estimating process 10 may determine a delta, or difference, between the estimate received from the estimator and the actual results of the resources required for accomplishing the task and/or component. As such, estimating process 10 may store and/or be capable of accessing historical information regarding one or more previous estimates by an estimator, including one or more of the task and/or component with which the estimate is associated, the raw estimate made by the estimator, and the actual resources utilized to accomplish the task and/or component. Further, estimating process 10 may store, be capable of accessing, and/or capable of calculating the delta between the one or more previous estimates and the actual results associated with each estimate. It will be appreciated that initially there may be no historical information associated with an estimator.

Generating 106 the adjusted estimate may also include determining 110 an adjustment metric based upon, at least in part, the accuracy of the one or more prior estimates by the estimator. For example, estimating process 10 may determine 110 an adjustment metric based upon the determined 108 accuracy of one or more prior estimates of the estimator, such that the adjustment metric may compensate for the delta between the raw estimate and actual results for one or more previous estimates by the estimator. For example, if the one or more prior estimates by the estimator were 20% higher than the actual results, an adjustment factor may be determined 110 to compensate for the over estimate, for example by providing a 0.83 multiplier. It will be appreciated that adjustment metrics other than a simple multiplier may be utilized. For example, the adjustment metric may be based upon various statistical analysis of the one or more previous estimates by the estimator, such as the mean, median, mode, standard deviation, variance, or other more sophisticated determination 108 of the accuracy of the one or more prior estimates. For example, trending patterns associated with the one or more prior estimates may be considered, e.g., which may indicate that the estimates by the estimator are becoming increasingly more accurate over time. As such, a determined 110 adjustment metric may take into consideration that the received 104 raw estimate may be more accurate than previous estimates by the estimator. As such, the determined 110 adjustment metric may provide less aggressive compensation than would be indicated by an average accuracy of the estimator, or even than would be indicated by the most recent prior estimate by the estimator. Additional considerations, such as the frequency of estimates by the estimator may also be considered.

According to an embodiment, the adjustment metric may be a global adjustment metric, e.g., which may be based upon all prior estimates by the estimator. In some embodiments, the adjustment metric may be scoped, at least in part, by the domain of the task and/or one or more components of the current estimate being considered. For example, the adjustment metric may be determined 110 based upon, at least in part, only previous estimates for common or similar tasks, and/or common or similar components. For example, for a given estimator, a prior estimate of work units to implement database integration for a e-commerce platform may have limited relevance to a current estimate for work units to code a user interface for an online game registration. As such, the determined 108 accuracy of the prior estimate associated with implementing database integration may not be considered to determine 110 an adjustment metric for an estimate relating to a user interface of an online game registration. In some embodiments, the accuracy of one or more prior estimates for tasks and/or components that are less relevant to a current estimate being adjusted may be weighted based upon, at least in part, a determined or perceived degree of relevance to the current estimate being adjusted.

Estimating process 10 may further generate 106 the adjusted estimate, including applying 112 the adjustment metric to the raw estimate. For example, as generally discussed above, in some embodiments the adjustment metric may include a simple scaling factor, and applying 112 the adjustment metric may include multiplying the raw estimate by the adjustment metric. In other embodiments, applying 112 the adjustment metric to the raw estimate may involve various statistical methodologies, curve fitting algorithms, and/or other mathematical processes.

As generally discussed above, in some embodiments estimating process 10 may track the accuracy of the raw estimates and/or the adjusted estimates of the resources required for accomplishing the task and/or one or more components of the task. For example, estimating process 10 may determine 114 the actual amount of resources utilized for accomplishing the component. Determining 114 the actual amount of resources may include receiving an input from a user (e.g., the estimator and/or another user of estimating process 10), and/or may include receiving an input from another application, e.g., which may track the progress of the task and/or of one or more of the various component. Estimating process 10 may determine 114 the actual amount of resources utilized to accomplish the task and/or one or more component of the task once the task and/or component has been completed. Additionally/alternatively estimating process 10 may determine the actual amount of resources utilized during the progression of the task and/or components. Accordingly, estimating process 10 may determine 114 the actual amount of resources that are utilized to accomplish the task, and/or one or more components of the task.

Estimating process 10 may compare 116 the raw estimate with the actual amount of resources. As such, a delta between the raw estimate and the actual amount of resources may be determined. Similarly, estimating process 10 may compare the generated 106 adjusted estimate of the amount of resources with the actual amount of resources utilized to accomplish the task and/or one or more components of the task. Further, a delta may be determined between the adjusted estimate and the actual amount of resources utilized to accomplish the task and/or a component of the task.

Estimating process 10 may determine 118 an accuracy associated with the raw estimate. For example, based upon, at least in part, comparing 116 the raw estimate with the actual result (e.g., the actual amount of resources), the accuracy of the raw estimate may numerically quantified with respect to the actual result. Further, in some embodiments estimating process 10 may determine an accuracy associated with the adjusted estimate. For example based upon, at least in part, comparing 116 the adjusted estimate with the actual result, the accuracy of the adjusted result may be numerically quantified with respect to the actual result. In a embodiment, determining 118 the accuracy associated with the raw estimate may provide a feedback regarding the initial raw estimate received 104 from the estimator. The feedback may, for example, indicate how accurate the estimator is, whether the accuracy of the estimator's estimates is improving, becoming worse, or remaining static as well as various additional and/or alternative information. Similarly, determining the accuracy associated with the adjusted estimate may provide feedback regarding the quality and/or accuracy of the adjustment metric, the numerical analysis used to determine the adjustment metric, and/or the methodology used for one or more of determining the adjustment metric and applying the adjustment metric to the raw estimate.

Estimating process 10 may update 120 the adjustment metric based upon, at least in part, the determine accuracy associated with the raw estimate. For example, the accuracy of the raw estimate may change over time, an therefore the adjustment metric may be adjusted 120 to provide adjusted estimates having a relatively high degree of accuracy despite the changes in the accuracy of the raw estimate. For example, as the estimator becomes more experienced, the accuracy of his estimates may improve. As such, the raw estimate may not need to be compensated or adjusted to the same degree as was initially necessary. Accordingly, estimating process 10 may update the adjustment metric to provide a less aggressive adjustment, which may be reflective of the changes in the accuracy of the raw estimate. In other situations, the accuracy of the raw estimates from an estimator may deteriorate for various reasons, and/or may remain relatively unchanged. Estimating process 10 may update 120 the adjustment metric accordingly. Consistent with the foregoing, estimating process 10 may update the adjustment metric to compensate for changes in the accuracy of the raw estimate over time, and/or over a number of estimates received from a given estimator.

In some embodiments, estimating process 10 may update the adjustment metric based upon, at least in part, the determined accuracy associated with the adjusted estimate. For example, the adjustment metric may generally be intended to provide an adjusted estimate having a relatively high degree of accuracy (e.g., a higher degree of accuracy than the raw estimate). Based upon, at least in part, the accuracy of the adjusted estimate, estimating process 10 may update the adjustment metric e.g., to compensate for the quality and/or accuracy of the adjustment metric, the numerical analysis used to determine the adjustment metric, and/or the methodology used for one or more of determining the adjustment metric and applying the adjustment metric to the raw estimate.

In addition to adjusting a raw estimate to provide an adjusted estimate that may more accurately predict the resources that will be required to accomplish a task, and/or to accomplish one or more components of a task, estimating process 10 may provide analysis relating resource estimates that may provide indications of significant trends, or other information that may be useful in planning and/or managing business processes. For example, estimating process 10 may generate 122 a numerical analysis of one or more of the raw estimate and the adjusted estimate. Further, estimating process 10 may generate 124 a numerical analysis associated with the estimator and with one or more of the plurality of components. In some embodiments, the numerical analysis may be provided as reports. In some embodiments, estimating process 10 may receive report input parameters, e.g., which may indicate information or domains to be analyzed. Estimating process 10 may generate 122, 124 reports based upon, at least in part, the received report input parameters and the information collected and/or determined by estimating process (e.g., raw estimates, task definitions, componentization of tasks, adjusted estimates, actual results, adjustment metrics, accuracies of raw estimates and adjusted estimates, and the like).

Estimating process 10 may generate 122 a numerical analysis, which may be provided as a report or presentation of data, regarding one or more of a raw estimate and an adjusted estimate. In some embodiments, the numerical analysis may regard raw and/or adjusted estimates associated with a specific task, or task type, or a specific component, or component type. Further, the numerical analysis may be specific to an individual estimator, or may contemplate estimates by a group of estimators. For example, a numerical analysis may be generated for the accuracy of raw estimates by all estimators for a specific component, such as developing a specific database integration into software products. Such a numerical analysis may, for example, indicate the overall estimate accuracy for all estimators, which may provide project managers with insight as to how well such work items are being estimated by a group or team. For example, if the numerical analysis indicates a wide accuracy variance associated with the specific component across all estimator and over an extended period of time, a project manager may determine that estimating the resources for the specific component is particularly challenging. As such, either greater lee-way for resource need may be incorporated into tasks including the component, or substitutions or work-arounds may be used to eliminate the component that is difficult to estimate.

Estimating process 10 may generate 124 numerical analysis relating an individual estimator and one or more of the plurality of components. For example, estimating process 10 may generate 124 a numerical analysis of the estimate variance for a specific estimator and a specific component over time. In a particular example, the numerical analysis may indicate a wide variance in estimate accuracy for the specific estimator and the specific component over time. The wide variance in accuracy may indicate that the estimator does a poor job of estimating for the component, and does not consistently overestimate or underestimate the requirements for the component. The consistently may present challenges for generating adjusted estimates and may suggest to a project manager that the estimator may require additional training for making the estimates, and/or should not be used for providing estimates for the component.

As generally discussed above, estimating process 10 may track and report basic accuracy metrics, such as mean, median, mode, standard deviation, and variance per component and per estimators. Such analysis may provide useful information such as evaluating specific estimators to determine how well-suited they are for providing estimates for specific components, evaluating specific components to determine how likely they are to be estimated accurately by a project's estimators, identifying trends that may indicate how estimators are performing over time, overall and as related to individual components. Such metrics and analysis may allow informed adjustments to be made to the raw estimates received by estimating process 10. In addition to basis accuracy metrics, more sophisticated numerical method may be utilized, such as generating an uncertainty distribution that may be used to model the variance of the estimates of a given component or estimator. Such a model could be updated over time based on the accumulated estimate accuracy data.

Assume, for illustrative purposes, a software development project that follows an agile development methodology. In an example, the overall project may be divided into a number of iterations in which individual development tasks are planned and completed. An iteration may begin by gathering estimates for each task. The aggregation of the estimates may, for example, determine how much work is planned for each iteration. Consistent with such an example, the individuals making the estimates of how much work may be required for each task may include software developers. The tasks that make up each iteration may include use cases (i.e. features to be added to the system). Each use case may be broken up into one or more components that may be completed in order to accomplish the task. The components may include areas of expertise required for each task (e.g. user interface, web services, database). Continuing with the example, the amount of work for completing each component may be defined in terms of story points (e.g., and arbitrary unit of effort required to complete each component). Estimating process 10 may generate 106 an adjusted estimate for each component based upon, at least in part, one or more prior estimates by each estimator.

In addition to generating 106 the adjusted estimate, estimating process 10 may generate 122/124 various numerical analyses based upon, at least in part, the estimates, estimators, and components. The numerical analysis may indicate various trends or occurrences that may allow project managers, or other individuals, to take various actions for improving the execution of the business processes, and/or otherwise provide decision-making guidance or information. For example, numerical analysis may indicate that a given developer may chronically underestimates tasks involving user interface (UI) work (e.g., based upon the historical accuracy of his estimates relative to the actual amount of work required to accomplish the task or component). Utilizing the data from the numerical analysis, a manager of the software development team may make the developer aware of this trend (i.e., the chronic underestimation). If future estimates are not sufficiently improved, the developer who chronically underestimates the work required may no longer be given tasks that involve a UI component. In additional examples, analysis of estimates by developers may indicate that some individuals frequently forget the documentation component of use cases when making estimates. Based upon, at least in part, this information the manager of the software development team may modify the estimation entry system to include a reminder to include the documentation component when componentizing tasks. Further, a given developer may consistently provide accurate estimates for tasks involving a web services component, as indicated by numerical analysis of the estimates provided by the developer. The developer may, therefore, be designated as the software development team's subject matter expert in this area and may be asked to provide assistance in the future estimates of other developers.

In addition/as an alternative to providing analysis and reports regarding the estimators, estimating process 10 may generate numerical analysis regarding one or more components for which estimates may be provided. For example, analysis of per-component data may indicate that estimate accuracy for tasks involving a database component vary widely across all developers. In consideration of this indicated trend, the team manager may require each developer to complete coursework in this area to improve the team's overall competency. In another example, the user interface (“UI”) component of a project may be indicated as taking a much larger percentage of available time than expected. Based upon, at least in part, this information, a trade study may be conducted to find alternative UI approaches that are easier to implement.

In another illustrative example, pertaining to supply chain management, the process of managing a company's supply chain may be considered. For example, being able to accurately estimate deliveries may be critical to proper maintenance of the company's inventory. Various different estimates relating to supply chain management may be provided by suppliers and carriers regarding tasks such as inventory deliveries. The inventory deliveries tasks may be broken into components such as product types, delivery routes, and transportation modes. In this example, the estimates for the inventory deliveries may be terms of days. Based upon, at least in part, the estimates provided by the suppliers and carriers, the actual time required for the deliveries across different product types, delivery routes, and transportation modes, various trends or information may be determined. For example, numerical analysis on a per-estimator perspective may indicate that a given supplier has experienced several manufacturing delays in the past year. As such, an alternative supplier may be chosen, e.g., to alleviate inventory ramifications of the delays by the supplier. In another example, a given carrier may be proven to be highly accurate in its estimates throughout the northeast (e.g., as a result of a comparison of raw estimates to actual results, accuracy variance, and/or other considerations). In consideration of the high accuracy, more business from this northeast (e.g., the region for which accurate estimates may be provided) may be directed to this carrier.

Similarly, various analysis of components of the different tasks may also provide indications of trends or other information that may be useful in managing the company's supply chain. For example, a certain product type may be constantly plagued by delays due to complicated manufacturing processes. The constant delays may exists across all suppliers (e.g., which may be indicated by regularly occurring inaccuracies in estimates and/or a relatively wide variation in the accuracy of estimates for all suppliers). In view of the delays across all suppliers, research may be conducted to find a replacement part, to thereby eliminate the delays. In another example, deliveries that go through Atlanta, regardless of transportation mode, may have a higher estimate accuracy variance as compared to deliveries that go through other cities. Based upon, at least in part, this awareness, time sensitive deliveries may not be sent through Atlanta. In yet another example, estimates for air transportation may generally be much less accurate than those for ground transportation. In consideration of the lower accuracy, greater allowances may be made for delivery tasks involving air transportation.

Various additional and/or alternative implementations, use cases, and analytics may be equally implemented. For example, while various operations have been provided with sequence numbers in the example embodiment of FIG. 3, it will be appreciated that various operations may be performed in a sequence that is different than the depicted example embodiment. For example, performing operations in a sequence that is different than depicted in the example embodiment may include performing the identified operations in a different order, combining two or more of the identified operations into a single operation, dividing a single identified operation into two or more additional operations, eliminating one or more operations, and/or including one or more additional operations. As such, the numbering utilized in connection with FIG. 3, should be considered for the purposed of facilitating understanding of the depicted example embodiment, and should not be construed as a limitation on the present disclosure.

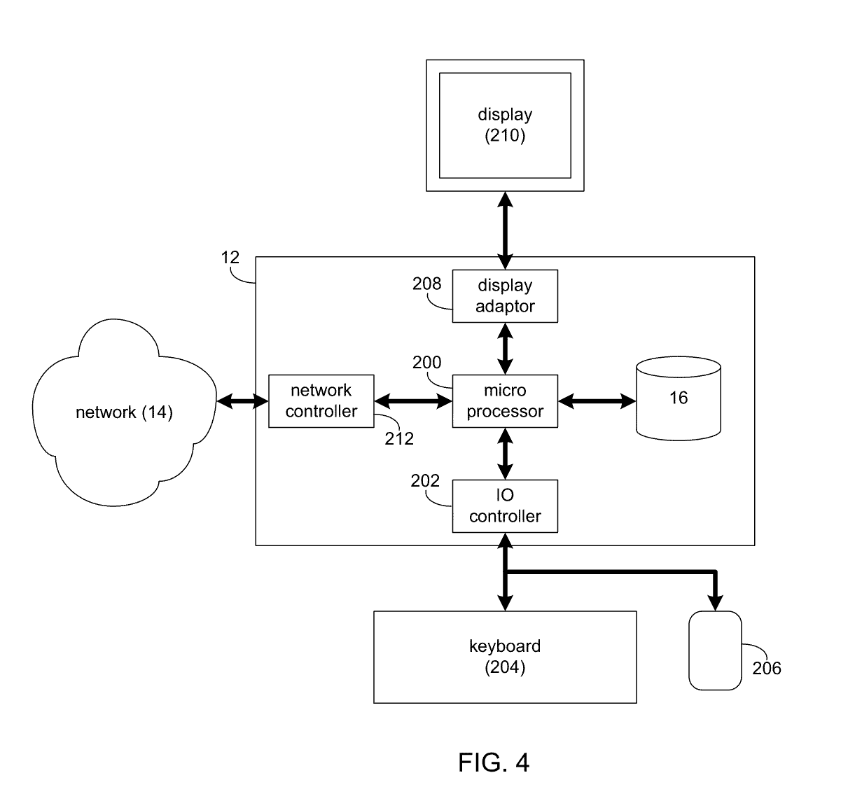

Referring also to FIG. 4, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, estimating process 10 may be substituted for computing device 12 within FIG. 4, examples of which may include but are not limited to client electronic devices 28, 30, 32, 34.

Computing system 12 may include microprocessor 200 configured to e.g., process data and execute instructions/code for screen capture process 10. Microprocessor 200 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 202 may be configured to couple microprocessor 200 with various devices, such as keyboard 204, mouse 206, USB ports (not shown), and printer ports (not shown). Display adaptor 208 may be configured to couple display 210 (e.g., a CRT or LCD monitor) with microprocessor 200, while network adapter 212 (e.g., an Ethernet adapter) may be configured to couple microprocessor 200 to network 14 (e.g., the Internet or a local area network).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1.-7. (canceled)

8. A computer program product comprising a computer readable medium having a plurality of instructions stored thereon, which, when executed by a processor, cause the processor to perform operations including:
defining a task;
defining a plurality of components associated with the task;
receiving a raw estimate of an amount of resources required for accomplishing a component of the plurality of components from an estimator; and
generating an adjusted estimate of the amount of resources required for accomplishing the component based upon, at least in part a historical accuracy associated with the estimator.

9. The computer program product of claim 8, wherein generating the adjusted estimate comprises:
determining an accuracy of one or more prior estimates by the estimator; and
determining an adjustment metric based upon, at least in part, the accuracy of the one or more prior estimates by the estimator.

10. The computer program product of claim 9, further comprising instructions for applying the adjustment metric to the raw estimate.

11. The computer program product of claim 8, further comprising instructions for:
determining the actual amount of resources utilized for accomplishing the component;
comparing the raw estimate with actual amount of resources; and
determining an accuracy associated with the raw estimate.

12. The computer program product of claim 11, further comprising instructions for updating an adjustment metric based upon, at least in part, the determined accuracy associated with the raw estimate, the adjustment metric utilized, at least in part for generating the adjusted estimate.

13. The computer program product of claim 8, further comprising instructions for generating a numerical analysis of one or more of the raw estimate and the adjusted estimate.

14. The computer program product of claim 8, further comprising instructions for generating a numerical analysis associated with the estimator and with one or more of the plurality of components.

15. A computing system comprising a processor device and a memory module coupled with the processor device, the processor device configured for:
defining a task;
defining a plurality of components associated with the task;
receiving a raw estimate of an amount of resources required for accomplishing a component of the plurality of components from an estimator; and
generating an adjusted estimate of the amount of resources required for accomplishing the component based upon, at least in part a historical accuracy associated with the estimator.

16. The computing system of claim 15, wherein generating the adjusted estimate comprises:
determining an accuracy of one or more prior estimates by the estimator; and
determining an adjustment metric based upon, at least in part, the accuracy of the one or more prior estimates by the estimator.

17. The computing system of claim 16, wherein the processor device is further configured for applying the adjustment metric to the raw estimate.

18. The computing system of claim 15, wherein the processor device is further configured for:
determining the actual amount of resources utilized for accomplishing the component;
comparing the raw estimate with actual amount of resources; and
determining an accuracy associated with the raw estimate.

19. The computing system of claim 18, wherein the processor device is further configured for updating an adjustment metric based upon, at least in part, the determined accuracy associated with the raw estimate, the adjustment metric utilized, at least in part for generating the adjusted estimate.

20. The computing system of claim 17, wherein the processor device is further configured for generating a numerical analysis of one or more of the raw estimate and the adjusted estimate.
